(19) United States
(12) Patent Application Publication
(10) Pub. No.: US 2011/0182860 A1
(43) Pub. Date: Jul. 28, 2011

(54) BIOCONTROL COMPOSITE MICROBIAL AGENT PSX COMBINATION FOR CONTROLLING SEVERAL SOIL-BORNE DISEASES AND ITS BACTERIOLOGICAL COMPOSITION

(75) Inventors: Jianhua Guo, Jiangsu (CN); Hongxia Liu, Jiangsu (CN); Shimo Li, Jiangsu (CN)

(73) Assignees: NAU BIOGENIC PESTICIDES R&D CO., LTD., Jiangsu (CN); NANJING AGRICULTURAL UNIVERSITY, Jiangsu (CN)

(21) Appl. No.: 12/677,469

(22) PCT Filed: Dec. 11, 2009
(86) PCT No.: PCT/CN09/75496

§ 371 Date: Mar. 10, 2010

(30) Foreign Application Priority Data
May 27, 2009 (CN) 200910026866.9

(51) Int. Cl. A01N 63/00; A01P 1/00

(52) U.S. Cl. 424/93.3; 424/93.46

(57) ABSTRACT

A composite biocontrol microbial agent PSX combination controls several soil-borne diseases. The PSX combination was composed of three biocontrol bacteria, which are shaking cultured in the PDA culture solution at 37° C., 180 rpm for 20 to 24 hours, then centrifugated at 4000 g for 10 min, taking the wet bacterium preserved fluid by the ratio of 1:40 to prepare the microbial agent, and then mixing at the ratio of 1:1:1, the total concentration of live bacteria in finished product being of 1×10⁹˜1×10¹² cfu/mL. The PSX combination controls soil-borne diseases of plant that occurs complexly or solely, including root knot nematode disease, bacterial wilt, verticillium wilt and blights. Its disease-preventing effect is 60-100%. Yield increase is 30-200%. The effects of preventing Fusarium wilt of banana and rice sheath blight disease are more than 50%, and have 20-80% yield increase. In addition, the PSX combination also can improve soil hardening.

### FIELD OF THE INVENTION

The present invention relates to a biocontrol composite microbial agent that can control soil-borne diseases of a variety of crops, which belongs to disease prevention technology of crops, and is dedicated to harmless control of soil-borne diseases of a variety of crops,

### BACKGROUND OF THE INVENTION

Soil-borne plant pathogens are usually soil inhabitants, such as Ralstonia solanacearum which causes Solanaceae crops bacterial wilt, Fusarium oxysporium and Verticillium dahlaei that cause a variety of plant wilt and yellow dwarf diseases, Rhizoctonia solani Kuhn which causes rice sheath blight, and the Meloidogyne spp. which is more seriously endangering everywhere in recent years.

Solanaceae crops bacterial wilt is a global disease, and the pathogenic bacteria can infect more than 50 branches of 200 kinds of plants, resulting in global economic losses as much as 12 billion U.S. dollars; Phytophathora chili causes great loss on vegetable production in China all year round; root knot nematode (Meloidogyne spp.) infects protected vegetables, leading to the reduction of output for host by 15-25% all year round, sometimes more than 70%, which severely restricts the production and export of vegetables. During the production, these diseases tend to occur simultaneously, for example, the root-knot nematode disease, bacterial wilt and fungal wilt often occur in the tomato greenhouses simultaneously, thus form a composite infection and result in very serious loss.

The cultivation area and production of banana is number four in the rank of all fruit in China. Fusarium wilt of banana is a destructive soil-borne vascular bundle disease, and the pathogen spreads quickly, thus it is very difficult to be cured. The disease become more and more serious in recent years in China, and its incidence rate is 10% to 40%, even up to 90%.

Rice sheath blight is a serious global disease that influences the production of rice, and is also one of the three major diseases in China. Due to the strong saprophytic and wide host range of Rhizoctonia solani, especially the promotion of high quality rice varieties and the application of high productivity field close planting technology, the disease is becoming increasingly serious and causes some loss of rice production every year. The yield of rice can drop by 50% in serious region, which is a direct threat to the high and stable yield of rice. The sheath blight resistance varies in different rice varieties, but the immune and highly resistant variety has not yet been found.

These soil-borne diseases have characteristics of wide host range, strong stress resistance and difficult eradication, and the prevention and control of complex infection is particularly difficult. In production, it often not only lacks good disease-resistant varieties, but also lacks effective chemical control agents. The excessive use of chemical pesticides will bring a series of ecological and social problems, such as pest and grass resistance, direct harm to non-target organisms, pollution on the soil, water, and air, bio-accumulation effects on human health, and restrictions on pesticide residues in agricultural products in international trade. As early as 1992, United Nations Conference on Environment and Development (UNCED) has requested that “the sale and use of chemical pesticides should be controlled on a global scale,” and it has become the consensus of mankind that people can not be over dependent on chemical pesticides. With the development of economic, people's livelihood has been improved, and there is a growing emphasis on food safety issues, at the meanwhile, green vegetables, organic agricultural products and so on are also increasingly favored people.

Green vegetables have already become the mainstream of the world's vegetable production. China has began to conduct research and production of pollution-free vegetable since 1982, when a national biological control conference was convened, and JiangSu Province proposed replacing chemical pesticides with biological control firstly in the conference. In 1983, with the energetic support of the National Plant Protection Station, twenty-three provinces or municipalities carried out research, demonstration and promotion on green vegetables. Social needs of safe and healthy food promots the research on application of pollution-free methods to control pests. Through the following mechanisms, such as competition of space and nutrition, directly secreting extracellular enzyme with degradation, producing antibiotic to inhibit pathogen, and inducing resistance of plant, biocontrol strain can not only reduce environmental pollution caused by the use of chemical pesticides and improve farm value, but also can improve the soil micro-ecological environment and suppress pest populations, thus is beneficial to the sustainable production of crops and provide strong protection for the production of green vegetables in China.

Through several years of practice, people explore a set of integrated techniques for control of pests and diseases and reduction of pesticide pollution to produce green vegetables, and also develope a number of biological fungicide, such as agricultural streptomycin and Jinggangmycin, wherein, the former can be used to prepare a solution of 200 mg/L for controlling vegetable soft rot, bacterial wilt, and the later is used to prepare 1000-1500 times solution of controlling vegetables anthracnose, downy mildew. However, there is still no biocontrol agents which are able to simultaneously control soil-borne diseases of vegetables, bananas, rice and other crops at present. In existing technology, according to the method in patent for the bacteria preservative fluid of our laboratory (Publication No.: CN1358838, Publication Date: Jul. 17, 2002), biomass can be stored for 2 to 3 years at room temperature.

### CONTENTS OF THE INVENTION

### Technical Problem

The purpose of the present invention is to develop a composite biocontrol microbial agent for a variety of soil-borne disease, which is dedicated to prevention and treatment of vegetables bacterial wilt, blight, root-knot nematode, banana fusarium wilt, rice sheath blight and other soil-borne diseases, has high anti-microbial agent efficiency and also can increases production so as to solve the defects existing in current chemical pesticides for controlling soil-borne diseases, such as serious pollution and high cost, and improve the current situation that there is no high-efficient biocontrol agents against a variety of soil-borne diseases on.

### Technical Solution

The present invention relates to a composite biocontrol microbial agent PSX combination for controlling soil-borne diseases of various crops, comprising three kinds of bacterial components, i.e. PX35, SM21 and XY21. Both of the PX35 and SM21 strains belong to Bacillus spp., which were collected by China General Microbiological Culture Collection Center (CGMCC), and the collection numbers of PX35 and SM21 were CGMCC NO. 1930 and CGMCC NO. 2058 respectively. XY21strain belongs to Serratia sp., and is collected by CGMCC On May 24, 2007, with collection number of CGMCC No. 2059. The preparation method for the biological control agents is as follows:

1) Three strains PX35, SM21, and XY21 were inoculated into the PDA culture solution respectively and were cultured at 37□° C. 180 rpm, and 16-20 hours later, the optical density (OD) values of samples were measured at 600 nm in super-clean bench, using the uninoculated culture solution as control in the process; the preparation method of PDA culture solution was as follows: 200 g potatoes were peeled and cut into small pieces and then boiled in the boiling water, for at least 20 minutes, subsequently they were filtrated with four medical gauze; add 20 g ordinary sucrose into the filtrate and fix its volume to 1000 mL; the pH value was adjust to 7.2-7.4, and then couduct sterilization at 121□° C. for 20 minutes.

2) When the OD value was 0.5-0.8 in the culture, the seed liquid was added to PDA culture solution by volume ratio of 1:100, and was shaking cultured at 30□° C. 180 rpm for 20-24 h, then centrifuged at 4000 g for 10 min, thus there were 13-16 g wet bacteria per 1000 mL of culture medium and 4×10¹⁰-10¹⁵ bacteriaper gram of wet bacteria.

3) Wet bacteria and bacterial preservative liquid were mixed by the ratio of 1 g:40 mL, wherein, the bacterial preservative liquid was 0.01 mol/L phosphate buffer solution and also contained 0.001 mol/L Tween20; then the three strains of bacterial agents were well-mixed by the volume ratio of 1:1:1, thus the composite biocontrol microbial agent PSX combination was obtained, and the total concentration of live bacteria was 1×10⁹-1×10¹² cfu/mL in finished product.

### Beneficial Effects

The advantages and positive effects of the present invention are as follows: the subject matter of the present invention was a biocontrol agents against crop soil-borne diseases, which has much increased control effects on crop soil-borne diseases compared with other single biological bactericide bacteriophage with antibiotic spectrum, moreover, it had good control effects on multiple soil-borne diseases. The microbial agents of the present invention was a biological agents which has no problems caused by the chemical pesticide, so it was in favor of the production of green vegetables, and thus farmers can desuetude or decrease the pesticide dosage, which can not only save expense for farmers but also be beneficial to vegetables export. Meanwhile, the microbial agent also had the function of increase production, which can increase the income of farmers. The microbial agent was prepared by mixing of wet bacteria and bacterial preservation solution by the ration of 1:40 (g/mL), and it can be stored for 2-3 years at room temperature. Bacterial preservative solution was 0.01 mol/L phosphate buffer containing non-ionic surfactant, which was 0.001 mol/L Tween20.

The microbial agent can be made into composts through being poured into organic fertilizer before transplanting or be sprayed on the terrace with organic fertilizer before transplanting, and then buried in the soil with fertilizer in the process of soil preparation, or it also can be used in the irrigation root during the transplanting. After sprouting, the said agent can achieve the effect on controlling soil-borne diseases through a variety of biocontrol mechanisms.

The experiments showed that PSX combination can be used to control plant soil-borne diseases that complexly or solely occurred, such as tomato, pepper, cucumber, sponge gourd, watermelon and other fruits and vegetables root knot nematode disease, bacterial wilt, verticillium wilt and the blights, and its disease-preventing effect was 60-100% and the yield increase was 30-200%. The effects of preventing Fusarium wilt of banana and rice sheath blight disease are more than 50%, and have 20-80% yield increase. In addition, the PSX combination also can improve soil hardening.

The Preparation of PSX Combination

A composite biocontrol microbial agent PSX combination for controlling soil-borne diseases of various crops, comprising three kinds of bacterial components, i.e. PX35, SM21 and XY21. Both of the PX35 and SM21 strains belong to Bacillus spp., which were collected by China General Microbiological Culture Collection Center (CGMCC), and the collection numbers of PX35 and SM21 were CGMCC NO. 1930 and CGMCC NO. 2058 respectively. XY21strain belongs to Serratia sp., and is collected by CGMCC On May 24, 2007, with collection number of CGMCC No. 2059.

The preparation method of biological control agents is as follows:

1) Three strains PX35, SM21, and XY21 were inoculated into the PDA culture solution respectively and were cultured at 370□° C. 180 rpm, and 16-20 hours later the OD values of samples were measured at 600 nm in super-clean bench, using the uninoculated culture solution as control in the process; the preparation method of PDA was as follows: 200 g potatoes were peeled and cut into small pieces and then boiled in the boiling water for at least 20 minutes, subsequently they were filtrated with four medical gauze; added 20 g ordinary sucrose into the filtrate and fixed its volume to 1000 mL; the pH value was adjusted to 7.2-7.4, and then conducted sterilization at 121□° C. for 20 minutes.

2) When the OD value was 0.5-0.8 in the culture, the seed liquid was added to PDA culture solution by volume ratio of 1:100, and was shaking cultured at 30□° C. 180 rpm for 20-24 h, then centrifuged at 4000 g for 10 min, 13-16 g wet bacteria were in culture medium per 1000 ml and 4×10¹⁰-10¹⁵ bacteria were in wet bacteria per gram.

3) Wet bacteria and bacterial preservative liquid were mixed by the ration of 1 g:40 mL, wherein, the bacterial preservative liquid was 0.01 mol/L phosphate buffer solution and also contained 0.001 mol/L Tween20; then the three strains of microbial agents were well-mixed by the volume ratio of 1:1:1, the composite biocontrol microbial agents PSX combination was obtained, and the total concentration of live bacteria was 1×10⁹-1×10¹² cfu/mL in finished product.

### Implementation Effect

### 1. Biocontrol Efficacy of PSX Family in Controlling Complex Occurrence of Bacterial Wilt, Hytophthora Blight and Root Knot Nematode Disease in Greenhouse

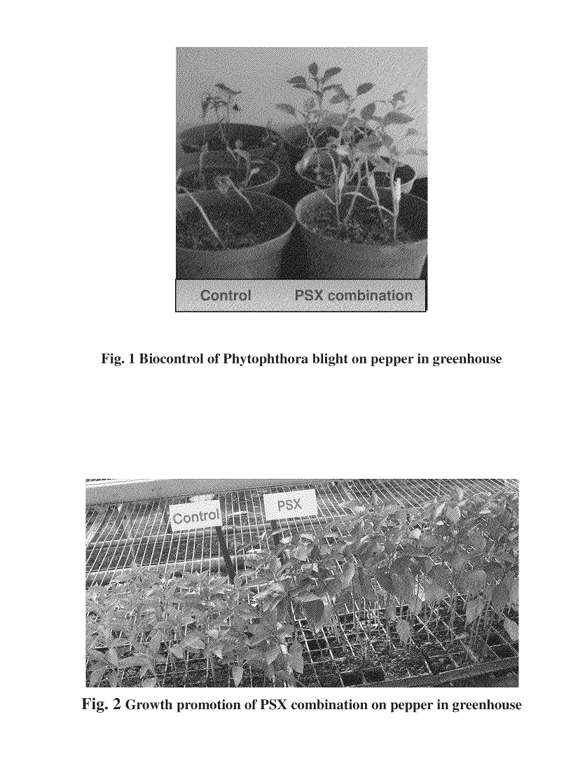

In the greenhouse experiment, we compared the biocontrol efficacy of PSX family that included 3 single strains AR156, SM21, and XY21; 3 two-strain combinations and PSX combination. We used 4 controls. Control 1 was only treated with fresh water; Control 2, 3 and 4 were respectively treated with streptomyces, metalaxyl-mancozeb and abamectin (the three pesticides are common pesticides for controlling bacterial wilt, blight and root knot nematode disease in China). The results were shown in Table 1 and FIG. 1.

TABLE 1
Biocontrol efficacy of PSX family in controlling complex occurence of bacterial wilt, phytophthora blight and
root knot nematode disease in greenhouse

| | Disease severity* (%) | | | Biocontrol efficacy (%) | | |
|---|---|---|---|---|---|---|
| | | | Root knot | | | Root knot |
| | Ralstonia | Phytophthora | nematode | Ralstonia | Phytophthora | nematode |
| Treatments | wilt | blight | disease | wilt | blight | disease |
| AR156 | 18.08 ± 2.4 | 30.10 ± 3.6^{d} | 17.88 ± 1.5^{e} | 64.39 ± 2.2 | 80.48 ± 4.3^{b} | 65.04 ± 3.1^{b} |
| SM21 | 27.60 ± 4.9^{cd} | 44.73 ± 4.5^{c} | 31.2 ± 3.2^{b} | 50.3 ± 2.7^{f} | 63.36 ± 3.6^{e} | 41.65 ± 2.7^{e} |
| XY21 | 32.50 ± 5.1^{c} | 60.30 ± 4.6^{b} | 28.94 ± 2.6^{bc} | 80.2 ± 3.2^{c} | 53.45 ± 2.7^{g} | 21.33 ± 1.6^{g} |
| AR156 + SM21 | 15.23 ± 2.3^{e} | 30.93 ± 3.8^{d} | 23.925 ± 2.2^{cd} | 75.27 ± 3.2^{d} | 79.83 ± 2.7^{b} | 65.53 ± 4.7^{b} |
| AR156 + XY21 | 15.35 ± 2.6^{e} | 29.30 ± 2.6^{d} | 20.88 ± 1.5^{de} | 82.85 ± 4.7^{b} | 71.79 ± 4.4^{c} | 51.01 ± 2.5^{c} |
| SM21 ± XY21 | 21.95 ± 4.1^{de} | 41.35 ± 2.6^{c} | 27.43 ± 2.1^{bc} | 82.71 ± 4.8^{b} | 57.66 ± 2.4^{f} | 36.05 ± 2.4f |
| AR156 + SM21 + XY21 | 6.88 ± 2.5^{f} | 13.94 ± 1.5^{e} | 11.98 ± 1.0^{f} | 92.25 ± 3.9^{a} | 85.94 ± 5.1^{a} | 73.45 ± 4.8^{a} |
| Control 1 | 91.23 ± 3.9^{a} | 76.65 ± 3.5^{a} | 88.65 ± 1.0^{a} | — | — | — |
| Control 2 | 53.53 ± 5.5^{b} | — | — | 39.71 ± 2.5^{g} | — | — |
| Control 3 | — | 40.35 ± 2.7^{c} | — | — | 67.62 ± 3.8^{d} | — |
| Control 4 | — | — | 30.58 ± 2.7^{b} | — | — | 47.36 ± 3.3^{d} |

*Disease severity was calculated according to the disease index of bacterial wilt, phytophthora blight, root knot nematode disease. The values are means ± S.D, followed by the different letters within a column are significantly different as determined by the Duncan test (P = 0.05).

### 2. Growth Promotion of PSX Family on the Pepper in Greenhouse

Table 2 showed the plant growth promotion efficacy of each single bacterial strain, each two-strain combinations of the PSX family and PSX combination. The PSX combination showed the strongest effects on plant growth promotion, biomass was increased by 64.67%; while the other treatments in the PSX family had the 4.85-21.14% biomass increases. The increases of both root freshweight and shoot freshweight (96.19% and 59.73%) caused by the PSX combination were significantly higher than the counterparts (11.74-50.33% and 3.79-16.63%) by the other treatments in the PSX family.

TABLE 2
Growth promotion efficacy of PSX family on pepper in the greenhouse

| | | | | Shoot | | |
|---|---|---|---|---|---|---|
| | Root | Root | Shoot | freshweight | Total fresh | Biomass |
| | freshweight* | freshweight | freshweight* | increase | weight* | increase |
| Treatments | (g/plant) | increase (%) | (g/plant) | (%) | (g/plant) | (%) |
| AR156 | 0.401 ± 0.0^{c} | 17.68 ± 2.5^{e} | 2.496 ± 0.0^{bc} | 12.94 ± 2.01^{cd} | 2.897 ± 0.1^{bc} | 13.58 ± 1.2^{e} |
| SM21 | 0.482 ± 0.0^{b} | 41.67 ± 2.3^{c} | 2.505 ± 0.2^{bc} | 13.35 ± 1.56^{c} | 2.987 ± 0.2^{bc} | 17.14 ± 2.2^{c} |
| XY21 | 0.381 ± 0.0^{cd} | 11.74 ± 1.2^{g} | 2.293 ± 0.1^{bc} | 3.79 ± 0.49^{e} | 2.674 ± 0.2^{cd} | 4.85 ± 0.9^{f} |
| AR156 + SM21 | 0.512 ± 0.0^{b} | 50.33 ± 2.8^{b} | 2.577 ± 0.1^{b} | 16.63 ± 1.75^{b} | 3.089 ± 0.2^{b} | 21.14 ± 2.5^{b} |
| AR156 + XY21 | 0.393 ± 0.0^{cd} | 15.26 ± 1.8^{f} | 2.496 ± 0.2^{bc} | 12.98 ± 1.55^{cd} | 2.889 ± 0.2^{bc} | 13.28 ± 1.8^{e} |
| SM21 + XY21 | 0.466 ± 0.1^{b} | 36.83 ± 1.9^{d} | 2.471 ± 0.1^{bc} | 11.81 ± 1.74^{d} | 2.937 ± 0.2^{bc} | 15.16 ± 2.2^{d} |
| AR156 + SM21 + | 0.669 ± 0.0^{a} | 96.19 ± 5.1^{a} | 3.530 ± 0.2^{a} | 59.73 ± 3.91^{a} | 4.199 ± 0.3^{a} | 64.67 ± 4.8^{a} |
| XY21 | | | | | | |
| Control** | 0.341 ± 0.0^{d} | 0.00 | 2.210 ± 0.1^{c} | 0.00 | 2.550 ± 0.1^{d} | 0.00 |

*The data shown were the average of three repetitions of this experiment. The values are means ± S.D, followed by the different letters within a column are significantly different as determined by the LSD test (P = 0.05). The data were expressed as the average of three repetitions.
**Control means that the seedlings were treated with fresh water.

### 3. Biocontrol Efficacy of PSX Combination Against Complex Diseases on Pepper in the Field

The complex diseases including bacterial wilt, phytophthora blight, and root knot nematode disease regularly occurred at Huaian district of Shandong province and Linyi districts of Jiangsu province. Ninety days after the treatment of PSX combination in Huaian districts, the PSX combination achieved total biocontrol efficacy of 79.05% and yield increase of 149.2%, while the chemical pesticides showed total biocontrol efficacy of 52.55% and yield increase of 80.0% (Table 3 and 4). The similar results were obtained in Linyi districts of Shandong province.

TABLE 3
Biocontrol efficacy against complex disease and pepper yield increase 90 days after PSX
treatment in the field of Huaian city, Jiangsu province

| | Disease severity (%)* | | | Total | | |
|---|---|---|---|---|---|---|
| | | | Root knot | biocontrol | | Yield |
| | Ralstonia | Phytophthora | nematode | efficacy | Yield | increase |
| Treatments | wilt | blight | disease | (%)* | (g/plant)* | (%)* |
| PSX | 2.81 ± 0.14^{c} | 2.29 ± 0.32^{c} | 2.26 ± 0.25^{c} | 79.05 ± 6.02^{a} | 309.5 ± 112.5^{a} | 149.2 ± 7.3^{a} |
| Control | 12.44 ± 2.23^{a} | 14.67 ± 1.15^{a} | 6.12 ± 0.78^{a} | — | 124.2 ± 71.6^{c} | — |
| 1** | | | | | | |
| Control | 4.55 ± 0.62^{b} | 8.47 ± 1.54^{b} | 3.75 ± 0.19^{b} | 52.55 ± 7.11^{b} | 223.5 ± 88.3^{b} | 80.0 ± 4.5^{b} |
| 2** | | | | | | |

*The values of means ± S.D. The ones labeled with the different letters within a column are significantly different as determined by the Duncan test (P = 0.05). This experiment was repeated 3 times.
**Control 1 in which seedlings were only treated with water. In Control 2, the roots of seedlings were jointly treated with streptomyces, metalaxyl-mancozeb, and abamectin.

### 4. Biocontrol Efficacy of PSX Combination Against Complex Disease.

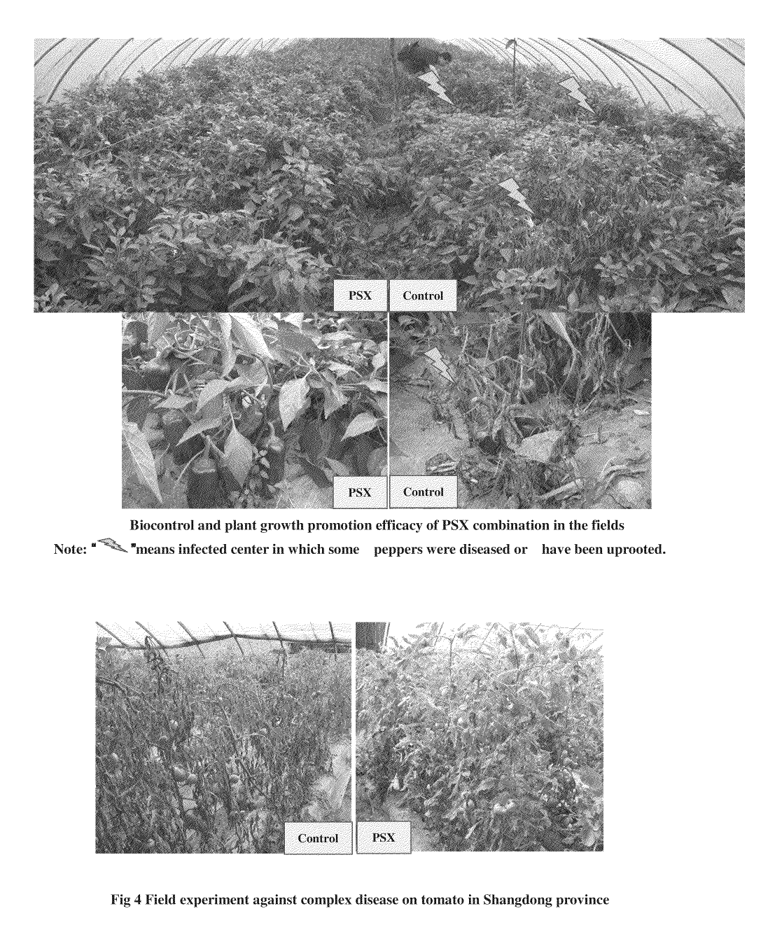

Using PSX combination, we did the field experiment in the plastic houses where a complex disease including Fusarium wilt, Root knot nematode disease, and Phytophthora bligh has happened for 8 years in Shangdong province. The results were shown in Table 4 and FIG. 4.

TABLE 5
Field experiment on tomato in Shangdong province (2008)

| | Disease | | | |
|---|---|---|---|---|
| | severity | Biocontrol | Yield | Yield |
| Treatments | (%) | efficacy (%) | (Kg/plot**) | increase (%) |
| PSX | 21.5 ± 1.71^{b} | 74.22 ± 1.01 | 34.43 ± 0.49^{b} | 61.18 ± 0.55 |
| combination | | | | |
| Water | 83.4 ± 3.49^{a} | — | 21.36 ± 0.21^{a} | — |
| control | | | | |

Note:
*Means followed by the different letters within a column are significantly different as determined by the LSD test (P = 0.05). Data represent means of experiment with 4 replications each.
**Each plot was 4 m in length and 4 m in width, and 100 pepper seedlings were planted

### 5. Biocontrol Efficacy of PSX Combination Against Complex Disease on Cucumber in the Field.

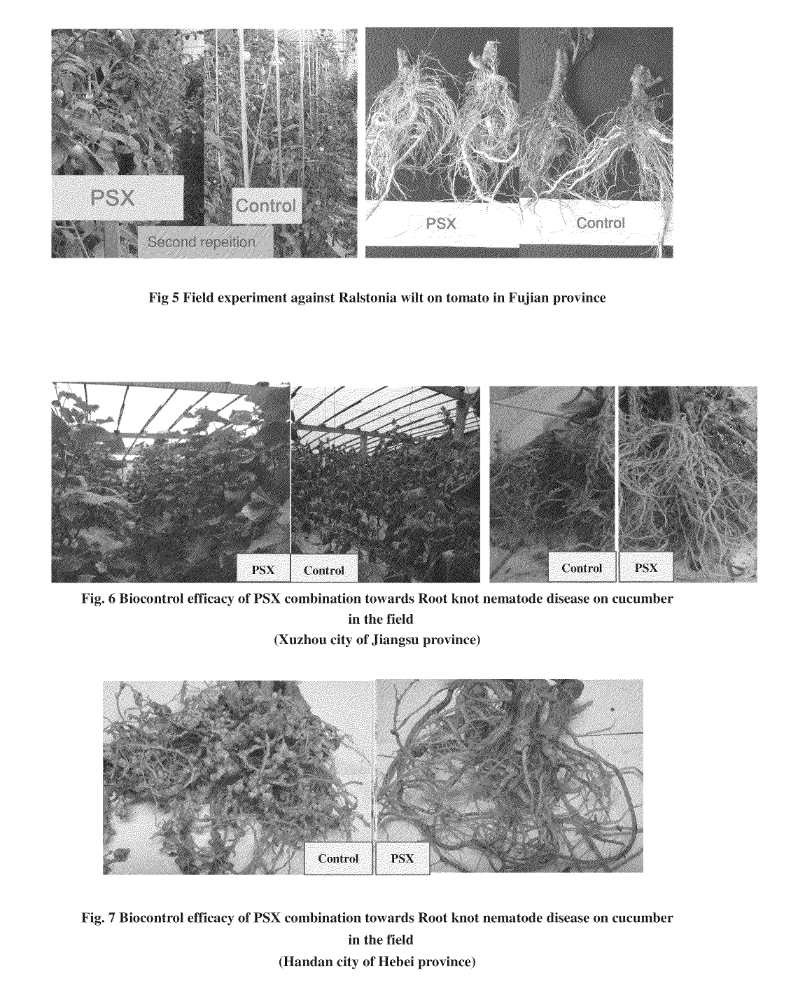

In the experiment field of Tongshan county, Xuzhou city of Jiangsu province, the cucumber had already been grown 10 years. Meloidogyne root-knot had happened very seriously, and mixed with other root-knot diseases which we had not determined the pathogen. The farmer planned to grow rice instead in 2006. We did this biocontrol experiment in 2007. The result was shown in Table 5 and FIG. 6. In another field experiment in Yongnian, Handan city of Hebei province, PSX combination achieved the biocontrol efficacy of 86.5% towards root knot nematode disease, and yield increase of 56.4%. It shows obvious difference of cucumber roots in FIG. 7.

TABLE 6
Field experiment on cucumber in Xuzhou
city of Jiangsu province (2007)

| | Disease | | | |
|---|---|---|---|---|
| | severity | Biocontrol | Yield | Yield |
| Treatments | (%) | efficacy (%) | (g/plant) | increase (%) |
| PSX | 33.3 ± 3.1^{b} | 63.3 ± 1.01 | 1305.0 ± 38.7^{b} | 198.8 ± 31.5 |
| combination | | | | |
| Water | 91.1 ± 4.2^{a} | — | 436.7 ± 51.2^{a} | — |
| control | | | | |

Note:
* Means followed by the same letter within a column are not significantly different as determined by the LSD test (P = 0.05). Data represent means of experiment with 4 replications each.

### 6. Biocontrol Efficacy of PSX Combination Towards Root Knot Nematode Disease on Watermelon in the Field.

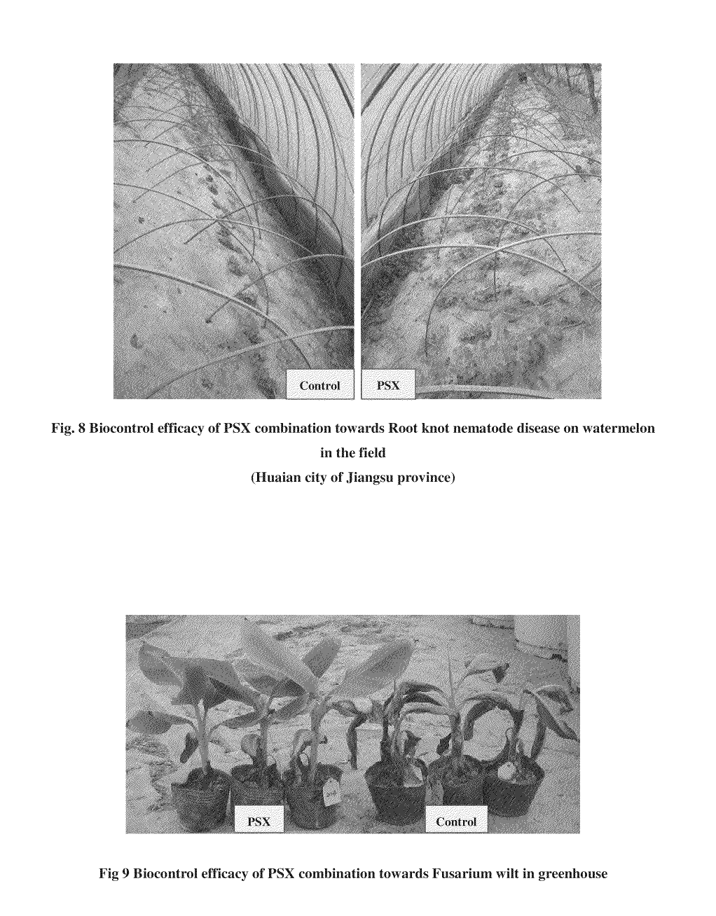

Watermelon is one of the most popular fruit in China and other countries. Unfortunately, many soil-borne pathogens are fond of this plant, sometimes they even destroy the whole field. The PSX combination controlled the complex soil-borne disease with the biocontrol efficacy of 70% except for the heavy rainy day. Table 7 and FIG. 8 showed the result of the field experiment that a farmer did in his own plastic house with the PSX combination in Huaian city of Jiangsu province.

TABLE 7
Field experiment on watermelon in Huaian
city of Jiangsu province (2008)

| | Disease | | | |
|---|---|---|---|---|
| | severity* | Biocontrol | Yield* | Yield |
| Treatments | (%) | efficacy* (%) | (kg/acre) | increase (%) |
| PSX | 7.67 ± 0.7^{b} | 72.0 ± 1.8 | 2733 ± 38.7^{b} | 41.8 ± 31.5 |
| combination | | | | |
| Water | 27.35 ± 2.3^{a} | — | 1928 ± 51.2^{a} | — |
| control | | | | |

Note:
*Means followed by the different letters within a column are significantly different as determined by the LSD test (P = 0.05). Data represent means of experiment with 3 replications each. Each plot was half plastic house (50 m in length and 4 m in width, and 100 pepper seedlings were planted)

### 7. Biocontrol Efficacy of PSX Combination for Controlling Fusaium Wilt on Banana in Greenhouse.

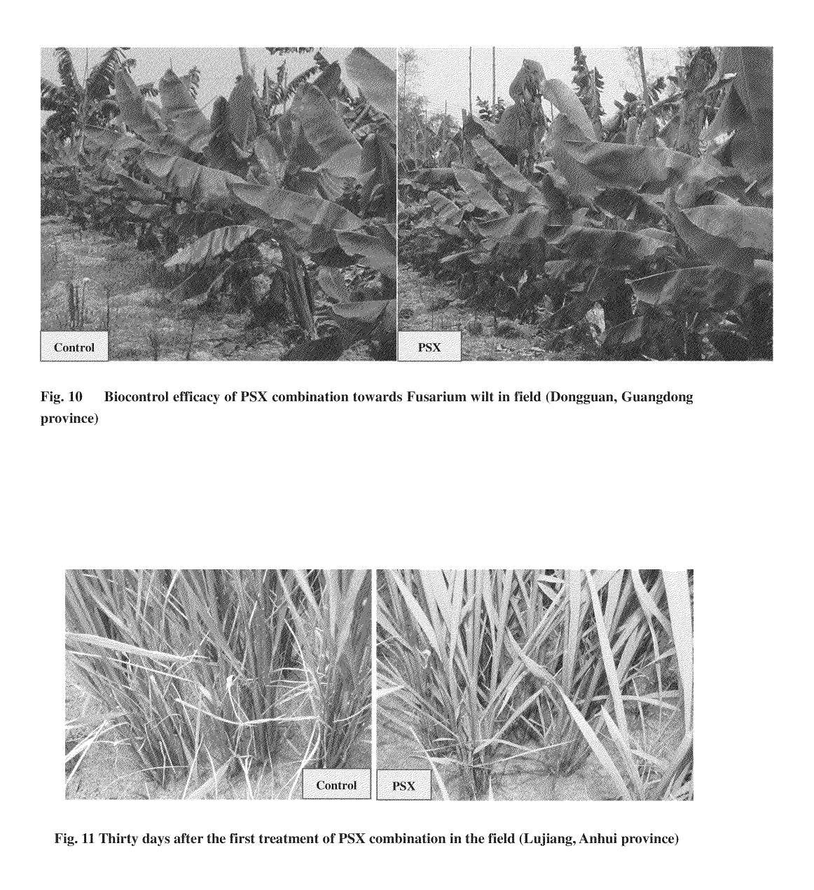

Banana wilt caused by Fusarium oxysporum seriously happens in Southern part of China, especially in Guangdong province. The PSX combination had the biocontrol efficacy of 53.23% and biomass increase of 27.55% in greenhouse (FIG. 9). In the fields experiment of 2009 in Zhuhai city of Guangdong province, it achieved the biocontrol efficacy of 75.02% after the bananas were transplanted for 4 months (Table 8). In Dongguan city, the biocontrol efficacy was 64.29% (FIG. 10). This field experiment will be finished in April of 2010, while it is estimated that the yield increase will be about 40-50% in the infected fields and 5-10% in the uninfected fields.

TABLE 8
Biocontrol and plant growth promotion of PSX combination
on banana in field (Zhuhai city, Guangdong province)*

| | Disease | |
|---|---|---|
| | severity* | Biocontrol |
| Treatments | (%) | efficacy (%) |
| PSX combination | 3.47 ± 0.01^{b} | 75.02 |
| Water control | 13.89 ± 0.08^{a} | — |

Note:
*Means followed by the different letters within a column are significantly different as determined by the LSD test (P = 0.05). Data represent means of experiment with 3 replications each. Each plot was 67 m² with 12 banana plants of line “Brazil”.

### 8. Biocontrol Efficacy of PSX Combination Towards Rice Sheath Blight in the Field.

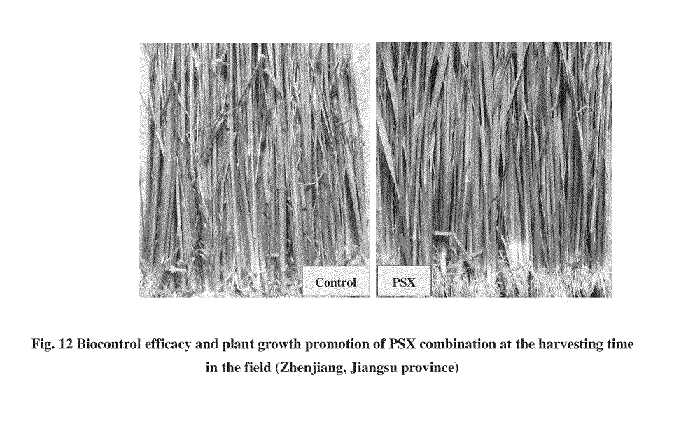

Rice the most important crop in China, and the sheath blight caused by Rhizoctonia solani is one of the most serious diseases in rice. We tried the PSX combination against rice blight in Lujiang county, Chaohu city of Anhui province, and obtained the better biocontrol efficacy than Jinggangmycin which is widely used to control this disease in China (Table 9, FIG. 11). The similar results were achieved in Zhenjiang city of Jiangsu province (FIG. 12).

TABLE 9
Biocontrol of rice sheath blight by PSX combination in
the field experiment (Lujiang county of Anhui province)

| | Disease severity (%) | | | | Control |
|---|---|---|---|---|---|
| Treatments | I | II | III | Means ± S.D | efficacy (%) |
| PSX combination | 17.50 | 15.30 | 15.67 | 16.49 ± 1.11^{c} | 81.22 |
| Jinggangmycin | 27.43 | 26.52 | 25.60 | 26.51 ± 0.91^{b} | 69.81 |
| (20%) | | | | | |
| Water control | 89.20 | 88.94 | 85.30 | 87.81 ± 2.18^{a} | — |

1. The PS combination is a biocontrol composite microbial agent that can prevent and control soil-borne diseases of a variety of vegetables, comprising two kinds of bacterial components: PX35 strain and SM21strain, both of which were Bacillus spp. and collected by China General Microbiological Culture Collection Center (CGMCC), wherein, PX35 was collected on Jan. 26, 2007 and its Culture Collection No. was CGMCC NO. 1930; SM21 was collected on May 24, 2007 and its Culture Collection No. was CGMCC NO. 2058. It has applied for Chinese patent application No. 200910026822.9, with the filing date of May 27, 2009, and it has claimed for international patent priority.

2. The PSX combination is a biocontrol composite microbial agent that can prevent and control soil-borne diseases of various crops, comprising three kinds of bacterial components, i.e. PX35, SM21, and XY21. Both of the PX35, SM21 strains belong to Bacillus spp., which were collected by China General Microbiological Culture Collection Center (CGMCC), and the collection numbers of PX35 and SM21 were CGMCC NO. 1930 and CGMCC NO. 2058 respectively. XY21strain belongs to Serratia sp., and is collected by CGMCC On May 24, 2007, with collection number of CGMCC No. 2059.

3. A method for preparing PS combination which is a biocontrol composite microbial agent that can prevent and control soil-borne diseases of various vegetables according to claim 1 has applied for Chinese patent application No. 200910026822.9, filing date of May 27, 2009, and it has claimed for international patent priority.

4. A method for preparing PSX combination which is a biocontrol composite microbial agent that can prevent and control soil-borne diseases of various crops according to claim 2, wherein
1) Three strains PX35, SM21, and XY21 according to claim 2, were inoculated into the PDA culture solution respectively and were cultured at 37° C. 180 rpm, 16-20 hours later the OD values of samples were measured at 600 nm in super-clean bench, using uninoculated culture solution as control in the process; the preparation method of PDA wasas follows: 200 g potatoes were peeled and cut into small pieces and then boiled into the boiling water for at least 20 minutes, subsequently they were filtrated with four medical gauze; add 20 g ordinary sucrose into the filtrate and fixed its volume to 1000 mL; the pH value was adjusted to 7.2-7.4, and then conducted sterilization at 121° C. for 20 minutes.
2) When the OD value was 0.5-0.8 in the culture, the seed liquid was added to PDA culture solution by volume ratio of 1:100, and was shaking cultured at 30° C. 180 rpm for 20-24 h, then centrifuged at 4000 g for 10 min, thus there were 13-16 g wet bacteria in per 1000 mL of culture medium and 4×10¹⁰-10¹⁵ bacteria were in per gram of wet bacteria.
3) Wet bacteria and bacterial preservative liquid were mixed by the ratio of 1 g:40 mL, wherein the bacterial preservative liquid was 0.01 mol/L phosphate buffer solution and also contained 0.001 mol/L Tween20; then the three strains of microbial agents were well-mixed by the volume ratio of 1:1:1, thus the biocontrol composite microbial agent PSX combination was obtained, and the total concentration of live bacteria was 1×10⁹ 1×10¹² cfu/mL in finished product.

5. The application of a biocontrol composite microbial agent PS combination for preventing and controlling soil-borne diseases of various vegetables according to claim 1 in the prevention and control of wilt, blight, and root-knot nematodes existing in greenhouse and field. It has applied for Chinese patent application on No. 200910026822.9, filing date of May 27, 2009 and claimed for international patent priority.

6. The application of a biocontrol composite microbial agent PSX combination for preventing and controlling soil-borne diseases of various crops and its active components according to claim 2 in prevention an control of various soil-borne diseases on vegetables, bananas, rice and other crops existing in the greenhouse and field.

7. The application of a biocontrol composite microbial agent PS combination for preventing and controlling soil-borne diseases of various vegetables according to claim 3 in the prevention and control of wilt, blight, and root-knot nematodes existing in greenhouse and field. It has applied for Chinese patent application on No. 200910026822.9, filing date of May 27, 2009 and claimed for international patent priority.

8. The application of a biocontrol composite microbial agent PSX combination for preventing and controlling soil-borne diseases of various crops and its active components according to claim 4 in prevention an control of various soil-borne diseases on vegetables, bananas, rice and other crops existing in the greenhouse and field.
